(19) United States
(12) Patent Application Publication
(10) Pub. No.: US 2003/0033305 A1
(43) Pub. Date: Feb. 13, 2003

(54) Method and system for using multi-media material to create a personalized product through a telecommunications medium

(76) Inventors: Matthew J. O'Connor, Delray Beach, FL (US); Jennifer O'Connor, Delray Beach, FL (US)

Correspondence Address: IP Administrator, Gunster, Yoakley & Stewart, Suite 1400, 500 East Broward Blvd., Ft. Lauderdale, FL, 33394, US

(21) Appl. No.: 09/736,979

(22) Filed: Dec. 14, 2000

Related U.S. Application Data
(60) Provisional application No. 60/170,679, filed on Dec. 14, 1999.

(51) Int. Cl. G06F 7/00

(52) U.S. Cl. 707/10

(57) ABSTRACT

A method and system which uses a telecommunication network to prepare a product. At least one title is stored in a database in which each title corresponds to an item available for incorporation in the product. The title is provided to a user via the telecommunication. At least one title selection is received from the user via the telecommunication network. Personal material is received from the user via the telecommunication network. A data file is assembled in which the data file includes the items corresponding to the selected title and the received personal material. The product is created such that the product is based on the data file.

### CROSS-REFERENCE TO RELATED APPLICATION

This application is related to and claims priority to U.S. Patent Application Serial No. 60/170,679, filed Dec. 14, 1999, entitled METHOD AND SYSTEM FOR USING MULTI-MEDIA VOICE, MUSIC, VIDEO, PICTORIAL GRAPHIC AND TEXT, MATERIAL TO CREATE A PERSONALIZED ITEM, THROUGH A TELECOMMUNICATIONS MEDIUM, the entirety of which is incorporated herein by reference.

### STATEMENT REGARDING FEDERALLY SPONSORED RESEARCH OR DEVELOPMENT

n/a

### FIELD OF THE INVENTION

The present invention relates to a method and system for selecting, over a telecommunications medium, a product for production and delivery, and in particular, to customizing, altering or modifying the selected product according to individual tastes and preferences, at a remote point of sale, for the purpose of producing a personalized product.

### BACKGROUND OF THE INVENTION

A popular name for product and service selection at a remote point of sale location, such as by a purchaser at a computer terminal connected by the Internet to a seller, is “e-commerce,” and is well known. E-commerce currently offers the advantage of shopping from the privacy of a home coupled with the act of “shopping” being under the control of the purchaser. The e-commerce shopper can, from a remote location, choose which products or site locations to shop and the order of presentation of the products and services at each such site location.

However, e-commerce carries certain problems which are not unique or unexpected with remote shopping. Because e-commerce is based on remote rather than “face to face” shopping, the opportunity to inquire about or discuss variations to the offered products or services is reduced. Products and services may be offered “as-is,” without variation in style, theme, or composition. Viewed from the perspective of seller to a shopper, shopping at the point of sale location, the e-commerce web site cannot promptly react and respond to immediate and spontaneous ideas, perceptions and concepts of the shopper, by offering an opportunity to apply those ideas, perceptions and concepts directly at the point of sale to increase the shopper's participation in the design of a personalized product and increase the involvement and commitment of the shopper to a purchase at that web site.

Products intended to be purchased as gifts are especially affected by a shopper's particular ideas, perceptions and concepts. Because a gift inherently incorporates an idiosyncratic element of a shopper's desires and motivations for purchasing the gift, the generally available composition and presentation of the gift does not always match such desires and motivations. Rather, shoppers are forced to modify their gift choices to fit one of a particular array of products offered at points of sale, either at physical locations, or through remote e-commerce sites.

It is therefore desirable to have a method and system which allows customers to select and customize a particular product from a remote point of sale location, through a telecommunications medium, in order to personalize the product according to the customer's unique tastes and desires.

Because e-commerce infrastructure currently allows for the efficient transmittal of multi-media content through a telecommunications medium, a particular type of product, that of multi-media audio and video products, such as music and movies, are well-suited to be served by this invention. It is therefore desirable to have a method and system which allows customers to choose and purchase an array of multi-media products, to be personalized by customers through a telecommunications medium for production and delivery of a custom multi-media product, preferably for use as gifts.

### SUMMARY OF THE INVENTION

This invention provides a method for using a telecommunication network to prepare a product, in which at least one title is stored in a database. Each of the titles correspond to an item available for incorporation into the finished product. A user receives, views, and selects the titles via a telecommunication network. The user also transmits personal material via the telecommunication network for incorporation in the finished product. The product is assembled in a data file, which includes the items corresponding to the titles selected by the user and the personal material sent by the user. The product is based on the data file, and manufactured accordingly.

This invention also provides a system of using a telecommunication network to prepare a product according the method disclosed above. The system includes a database of at least one title, in which each title corresponds to an item available for incorporation into the product. At least one server is coupled to the telecommunication network and is in communication with the database. The server has a central processing unit which: (i) provides titles to a user via the telecommunication network; (ii) receives via the telecommunication network a selection of titles chosen by the user; (iii) receives personal material from the user via the telecommunication network; and (iv) assembles a data file, the data file including the items corresponding to the selected titles and the received personal material; and (v) a production unit in communication with the at least one server. The assembled data file is transmitted by the server to a production unit which creates the product, the product being based on the data file.

The method and system of the invention thereby allows customers to select from an array of products available through a telecommunication network, add personal material to the product, for production and delivery of a custom product, such as a multi-media CD, DVD, or other desired gift product.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a block diagram of the system of the present invention;

FIG. 2 is a flow chart of the process by which the method of the present invention is executed.

### DETAILED DESCRIPTION OF THE INVENTION

According to the inventive principles of the present invention, a system and method is provided for selecting from a source of multi-media material, such as a VHS or DVD formatted video movie, an audio item such as a music CD or book on tape, or a graphical, pictorial or textual expression of a shopper's personalized concept, such as a drawing, image or poem, in order to create and provide a personal item which can be given as a gift. The system and method allows a shopper to remotely design a presentation or modify a suggested presentation, for that gift, to exactly fit the individual perceptions of the gift giver and the gift receiver. As would be known to one skilled in the art, the system and the method shown and disclosed in a preferred embodiment is not confined to the idea of a personalized gift, or a multi-media item, but may be applied to any other purpose or use without departing from the inventive principles disclosed and described. However, for the purpose of explanation, and without limiting the scope of the invention, the invention and the inventive principles will be described with reference to the remote selection and purchase of a personalized multi-media item or gift, through a telecommunications medium such as the Internet.

As used herein, the term “web site” refers to a related set of files which are maintained in one or more “web servers” and which, when transmitted to a user terminal, cause the user terminal to display and/or execute programmatic operation corresponding to the data contained in the files. Typically, the files comprising the web site are prepared using one or more of a combination of Hypertext Mark-Up Language (HTML), Extendable Mark-Up Language (XML), Java Applets, ActiveX programs, Standard Generalized Mark-Up Language (SGML) files and the like. Web site files are typically transmitted to the user terminal using one or more protocols such as the Hypertext Transfer Protocol (HTTP) under the Transmission Control Protocol/Internet Protocol (TCP/IP) suite of communication protocols.

Also as used herein, the term “browser” refers to an application program residing and executing on the user terminal which functions as an HTTP client, sending requests to web servers for web site files. The request is typically sent in the form of a Uniform Resource Locator (URL) or by selecting a hypertext link presented on the user terminal display. The browser functions to format the file and/or data received from the web server and format the received files and/or data in the manner described therein, displaying the same on the user terminal. Examples of browser programs include MICROSOFT INTERNET EXPLORER and NETSCAPE COMMUNICATOR.

As used herein the term “link” refers to a selectable connection from one word, picture or information object to another in which the selectable connection is presented within the web browser. The information object can include sound and/or motion video. Selection is typically made by “clicking” on the link using an input device such as a mouse, track ball and the like. Of course, one of ordinary skill in the art will appreciate that any method by which an object presented on the screen can be selected is sufficient.

As used herein the term “network connection” refers to any known arrangement for accessing communication networks, such as dial-up serial line interface protocol/point-to-point protocol (SLIP/PPP), integrated services digital network (ISDN), dedicated leased-line service, broadband (cable) access, frame relay, digital subscriber line (DSL), asynchronous transfer mode (ATM) or other access techniques.

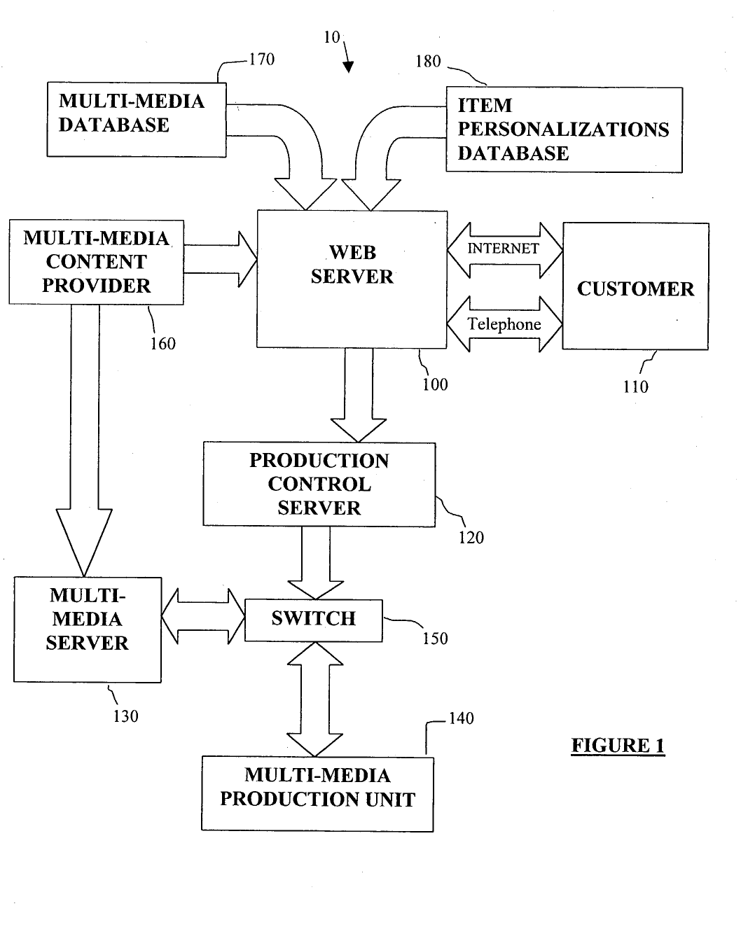

Referring now to the drawing figures, there is shown in FIG. 1 a system constructed in accordance with the principles of the present invention and designated generally as 10. System 10 includes a web server 100 for connection to and interaction with a customer 110. System 10 also includes a production control server 120, a multi-media server 130, a multi-media production unit 140, a switch 150, a multi-media content provider 160, a multi-media database 170, and an item personalizations database 180.

The web server 100 can be any general purpose computer designed or adapted to be a web server. The web server 100 also includes within it the general purpose computer, storage, addressing, routing, and retrieval systems, as would be known to one skilled in the art and selected by one skilled in the art in practicing the invention disclosed.

The web server 100 handles all order entry and purchase transactions with a customer 110. The customer 110 is understood to include a “user terminal” to connect, via a network connection, to the web server 100. Such user terminals have the ability to send and receive data across network connections, and are equipped with a web browser to display the received data on a display device incorporated therewith. By way of example, the user terminals may be personal computers such as Intel Pentium-class computers or Apple Macintosh computers, but are not limited to such computers. Other user terminals which can communicate over a global computer network such as Palmtop computers, personal digital assistants (PDAs) and mass-marketed Internet access devices such as WebTV can be used. In addition, the hardware arrangement of the present invention is not limited to devices which are physically wired to web server 100. It is contemplated that wireless devices using a wireless application protocol (WAP) can inter-operate with web server 100 using wireless data communication connections, as is well known to those skilled in the art.

Alternatively, the customer 110 communicates and interacts with the web server 100 via telephone, such as a through an automated voice response system, wherein the particular details of a transaction through the web server 100 are input by the customer 110. The web server 100 output is a unique data file containing all of a particular customer's choices and products selected therein.

Although the present invention is described by way of example herein in terms of a web-based system using web browsers and a web server 100, such a system is not limited to that particular configuration. It is contemplated that the connection between the web server 100 and customer 110 can be arranged such that customer 110 can communicate with, and display data received from, web server 100 using any known communication and display method, for example, using a non-Internet browser WINDOWS viewer coupled with a local area network protocol such as the Internetwork Packet Exchange (IPX).

As shown in FIG. 1, the web server 100 is locally connected or connected to a remote production control server (PCS) 120, for translation of shopper data files created on the web server 100 into the finished gift item (product). The web server 100 is preferably UNIX or NT based and all other servers are NT servers or other suitable devices as would be known to those skilled in the art. The PCS 120 is coupled to the web server 100, preferably by a Virtual Private Connection with a suitable back-up connection such as with an ISDN direct dial up or by a dedicated fiber optic line. The PCS 120 functions as the data processing center for the system, taking all customer data files created in the web server 100, and transmits the relevant requests for a particular multi-media product to the multi-media server 130 and multi-media production unit 140 via a high-speed data switch 150.

The multi-media server (also referred to as the “MMS”) 130 includes a series of multi-media digital databases of video, audio, image, graphic, and text material, selected by the customer 110 via the web server 100 and incorporated into tangible media in the multi-media production unit (also referred to as the “MMP”)140 for eventual delivery of the finished product. The MMP 140 comprises various hardware and subsystems for making and manufacturing the multi-media product, such as CD or DVD burners, custom silkscreen embossing machines, label printers, and other machines for creating packaging, keepsakes, and decorative items, all of which are well-known by those skilled in the art, to be delivered with the customer-selected multi-media product.

All of the servers disclosed in FIG. 1, including the web server 100, PCS 120, and MMS 130, preferably include one or more central processing units (CPU) used to execute software code in order to control the operation of such servers, read only memory (ROM), random access memory (RAM), one or more network interfaces to transmit and receive data to and from other computing devices across a communication network, storage devices such as a hard disk drives, floppy disk drives, tape drives, CD-ROM or DVD for storing program code, databases and application data.

The various components of web server 100, PCS 120, and MMS 130 need not be physically contained within the same chassis or even located in the single location. Furthermore, the nature of the invention is such that one skilled in the art of writing computer executable code (software) can implement the described functions of web server 100, PCS 120, and MMS 130 using one or more or a combination of popular computer programming languages including but not limited to “C++”, Visual Basic, Java, ActiveX, HTML, and web application development environments. Finally, although the present invention is described with respect to multiple servers, such as web server 100, PCS 120, and MMS 130, it is contemplated that the functions performed by web server 100, PCS 120, and MMS 130 can equivalently be implemented by fewer than three servers, for example, by a single server.

The customer 110 is first presented with a choice of multi-media products on the web server 100. Using a browser, customer 110 searches and selects, as more fully described below, an eventual choice of multi-media products to be produced, personalized, and delivered. The PCS 120 extracts the multi-media digital data from the MMS 130 and transmits it to the MMP 140. All of the multimedia products, including movies, music, literary works, and other copyrighted material are either proprietary to the purveyor of the multi-media product utilizing this system, or are duly licensed from a multi-media content provider 160, such as a publisher, record label, movie studio or authorized distributor therefor. The MMS 130 preferably is continuously and dynamically updated and stocked with multi-media content, for eventual purchase by the customer 110.

The web server 100 is linked to a multi-media database 170 (also referred to as an “MMD”). The MMD is stocked with indexes and catalogs of multi-media content resident on the MMS 130. The web server 100 is constructed to provide a search program to search the MMD 170 resources for a particular selection, in the event the customer 110 has some, but not all the information needed to identify a particular multi-media item. The search program is used to assist the shopper by using the artist name, title, writer, director, composer, label, publication date range, key word, or other suitable identifier criterion to find a particular item cataloged in the MMD 170.

The novel and inventive concepts and principles disclosed extend to the presentation of the item and by personalizing the item with a greeting or by personalizing the item's packaging and presentation. Personalizing the item may take the form of a graphic or written introduction or by the addition of sound bites or video bites, or in the case of text or graphics or pictorials, by adding special words, names, phrases or pictures or graphics, or similar material as an ending or at other locations in the record or the item, whatever it may be.

As the customer 110 proceeds through the selection process, the web server 100 prompts the customer 100 with other choices to personalize and add value to the item such as by adding other multi-media material or by special voice or visual introductions or endings. These personalized additions or “personalizations” may be generated from a database of greetings, introductions, or other messages already compiled on an “Item Personalization Database” 180 (also referred to as the “IPD”) linked to the web server 100.

The MMD 170 and IPD 180 are configured in FIG. 1 to be outside of the general program framework of the web server 100, and may be connected thereto by a suitable network connection. It is also contemplated that the invention can accomplish the same function by incorporating the MMD 170 and IPD 180 databases into one or more of servers 100, 120 and 130, without the need for separate elements or hardware.

The customer 110 also has the choice of adding personalized material to the selected item through his or her own original material transmitted to the web server to be used to personalize the item. This added material may be in any multi-media format, including digital audio and video files or clips, graphical or text materials. In such cases, the customer 110 is required to specify the point of insertion of the material. The customer 110 may transmit this added material via the Internet or other telecommunications network connecting customer 110 with the web server 100, such as via a telephonic connection using a toll-free telephone.

The final product selected by customer 110 on the web server 100 is a customized selection of an array of multi-media items: an amalgamation of video, audio, text or graphical items derived both from the products available on the MMS 130 as well as personalized additions transmitted by the customer 110.

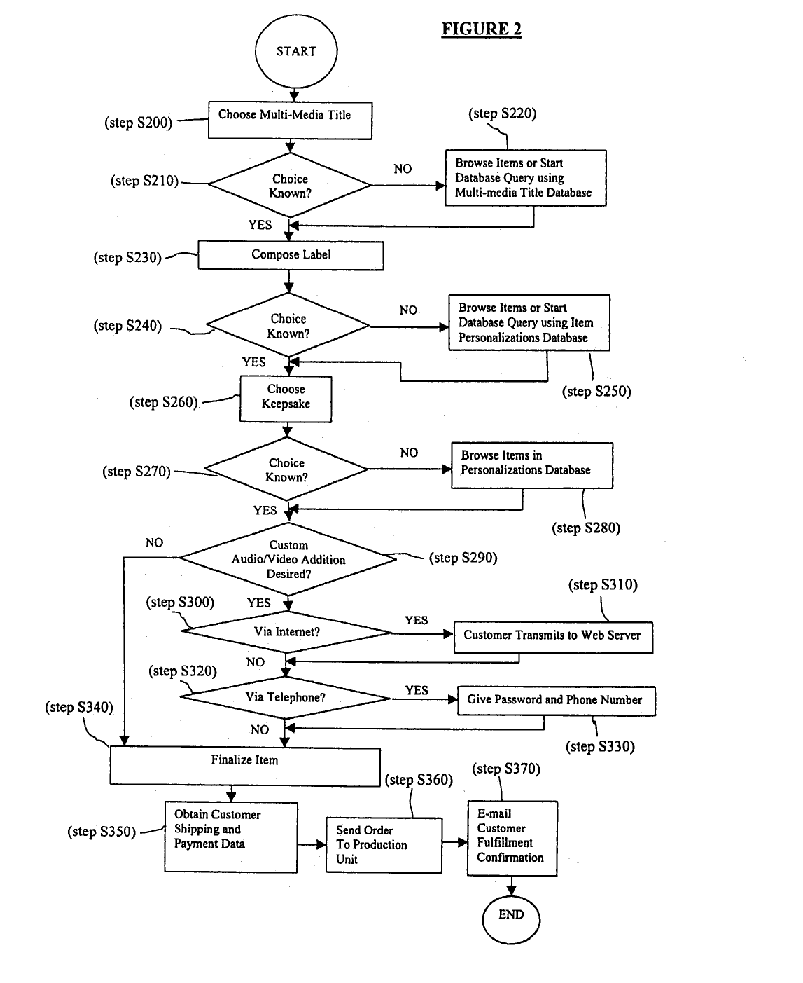

A more thorough discussion of the process by which the disclosed method and system is accomplished is described with reference to the flow chart in FIG. 2.

A customer 110 starts by connecting with the web server 110 and initiating the process of the present invention. First, the customer 110 enters the multi-media title selection program (step S200). The customer 110 then selects and chooses one or more multi-media titles (step S210). The multi-media title may be a plurality of titles, to include any number of music tracks, video selections, graphics and images, or literary titles presented as image text. If the customer 110 does not know aforehand the particular title he or she would like, the customer 110 may browse through MMD 170 or initiate a database query to search for particular items therein (step S220). The browsing or searching function performed in step S220 is tailored to allow a customer 110 to enter a particular name, title, date, or keyword for a multi-media item, which is then retrieved by the web server 100 from MMD 170, a function which is well known by those skilled in the art. Step S210 also allows the customer 110 to select the particular order of the titles, if more than one title is selected.

When all desired multi-media titles have been selected and arranged, the customer 110 proceeds to the composition of the label for the gift item (step S230). The labels may be for either the multi-media product itself, such as a custom silkscreen on a CD or DVD cover, or for any exterior packaging desired by the customer 110. The customer 110 must initially determine which label to place on the product (step S240). If the customer 110 does not know which particular label to use, he or she may utilize another browse and search function (step S250), much like step S220 for choosing the multi-media title, to select from any array of different label formats, content, and media, such as custom carrying cases, pictorial images embossed on the product, plaques to hold the product in place, customized engravings, and the like. In step S250, the customer 110 connects via the web server 100 to the IPD 180, wherein the customer 110 may select from any of the array of personalized greetings, labels, and messages contained therein.

In conjunction with the foregoing selection of a label, the customer 110 may proceed to choose a keepsake item to go with the personalized multi-media gift (step S260). The customer 110 must first determine if the particular keepsake item is known (step S270). If not, the customer 110 may browse though a variety of items offered through the web server 100 (step S280).

The web server 100 prompts the customer 110 to add any additional multimedia material to the selected product, label and packaging (step S290). Although the product is already highly personalized, the addition of unique and original multi-media material by the customer 110 is a particular element of the present invention. In step S290, the customer 110 may add his or her personal digital video, audio or graphical material to be included in the finished multi-media product he or she has chosen. In the case of video, the customer 110 may add a custom digital video clip, such as formatted using the MPEG or AVI standard; in the case of audio, the customer 110 may add a musical track, such as formatted using the MP3, AIFF, or WAV standard; in the case of graphics, the customer 110 may add a picture image, such as formatted using the JPEG or GIF standard. All of these items may then be added to the multi-media product is a fashion that the customer 110 chooses in step S290. Audio tracks may take the form of personalized voice recordings appended to or placed within a particular multi-media title. Similar effects may be accomplished using personalized video additions to selected video titles. A personalized digital image may be utilized as a label or cover for the product, such as a picture incorporated into the custom silkscreen provided for a finished CD or DVD.

The customer 110 has two options for transmitting his or her preferred personalized multi-media additions to the web server 100. The customer 110 can directly transmit a digital data file through the Internet through the same network connection to the web server (step S300). If so, the customer 110 sends the various digital data files to the web server 100 (step S310), where such files may then be converted to a different format for inclusion in the finished multi-media product. In the alternative, the customer 110 may transmit an audio clip, such as a voice introduction or greeting, to the web server 100 through the telephone (step S320). In such a case, the web server provides a toll free telephone number for the customer 110 to call and record a greeting. A password may be used for the purpose of security and identification (step S330).

After all of the custom multi-media material is added to the selected multimedia titles, the selection is completed and finalized (step S340). Next, the web server will prompt the customer 110 for payment and shipping data (step S350) to be assembled in a final order. The assembled final order is transferred to the PCS 120 (step S360). The transmission to the PCS 120 may be by local or wide area network or by the Internet, as the case may be. The PCS 120 places the order in its own individual file. Each of the separate elements required to assemble the finished product, such as the selection, the greeting, the display or arrangement or manner of presentation of the gift and any shopper contributed element such as a voice introduction or other multi-media material, and packaging data, is placed in the file in the form of data suitably arranged in a data file. The manner of arranging this data and its storage, is known to those skilled in the art and for that reason is not described.

Once the file has been completed, and the list of elements for an item is matched by a complete data file for that item, the gift is assembled in its finished form. As would be known to one skilled in the art, the CD and other audio elements would be recorded, the printed material such as the greetings, made, the voice introductions added and the gift packaged with the application of a suitable shipping label to the package selected or as personalized.

Upon completion of the multi-media gift, the web server 100 sends customer 110 a confirmation of the fulfillment of his or her order via electronic mail, or other contact method dictated to the web server 100 by customer 110 (step S370).

Although the foregoing method and process is disclosed in the context of a remote point of sale system such as a user terminal connected to a web server, a shopper, in using the inventive system and process, can place the entire order via a tool free number that connects the web server to the shopper. In the alternative, a voice automated system can be used in place of the web site prompts to prompt the shopper and take the order. Alternatively, kiosks may be placed in key locations, such as in malls, commuting areas or wherever there may be sufficient traffic, by which shopper places an order by phone or Internet. The personalized gift may also be produced on the spot.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. A method for using a telecommunication network to prepare a product, comprising:
storing at least one title in a database, each of the at least one title corresponding to an item available for incorporation into the product;
providing the at least one title to a user via the telecommunication network;
receiving via the telecommunication network, at least one title selection from the user;
receiving personal material from the user via the telecommunication network;
assembling a data file, the data file including the items corresponding to the at least one selected title and the received personal material; and
creating the product, the product being based on the data file.

2. The method according to claim 1, wherein a plurality of titles are selected and further including arranging the plurality of selections in a desired order.

3. The method according to claim 1, wherein the telecommunication network is an Internet.

4. The method according to claim 1, wherein the telecommunication network is a telephone system.

5. The method according to claim 1, wherein the items corresponding to the at least one selected title are multi-media items.

6. The method according to claim 1, wherein the personal material includes at least one of multi-media data, audio data and video data.

7. The method according to claim 1, further including receiving a label selection from the user via the telecommunication network.

8. The method according to claim 7, wherein the data file further includes data corresponding to the label selection.

9. The method according to claim 1, wherein the database further includes data corresponding to at least one personalized greeting, and further comprising:
receiving a personalized greeting selection from the user via the telecommunication network; and
retrieving the personalized greeting from the database corresponding to the selected greeting, the data file further including data corresponding to the retrieved personalized greeting.

10. The method according to claim 1, wherein the created product is one of a CD and a DVD.

11. A system for using a telecommunication network to create a product, comprising:
a database, the database including at least one title, each of the at least one titles corresponding to an item available for incorporation into the product;
at least one server coupled to the telecommunication network and in communication with the database, the at least one server having a central processing unit performing the functions of:
providing the at least one title to a user via the telecommunication network;
receiving via the telecommunication network, at least one title selection from the user;
receiving personal material from the user via the telecommunication network;
assembling a data file, the data file including the items corresponding to the at least one selected title and the received personal material; and
a production unit in communication with the at least one server, the production unit receiving the data file and creating the product, the product being based on the data file.

12. The system according to claim 11, wherein the telecommunication network is an Internet.

13. The system according to claim 11, wherein the telecommunication network is a telephone system.

14. The system according to claim 11, wherein the items corresponding to the at least one selected title are multi-media items.

15. The system according to claim 11, wherein the personal material includes at least one of multi-media data, audio data and video data.

16. The system according to claim 11, wherein the central processing unit in the at least one server further performs the function of receiving a label selection from the user via the telecommunication network.

17. The system according to claim 16, wherein the data file further includes data corresponding to the label selection.

18. The system according to claim 11, wherein the database further includes data corresponding to at least one personalized greeting, and wherein the central processing unit in the at least one server further performs the functions of:
receiving a personalized greeting selection from the user via the telecommunication network; and
retrieving the personalized greeting from the database corresponding to the selected greeting, the data file further including data corresponding to the retrieved personalized greeting.

19. The system according to claim 11, wherein the created product is one of a CD and a DVD.

20. The system according to claim 11, wherein the production unit comprises a kiosk.
